(19) United States
(12) Patent Application Publication
(10) Pub. No.: US 2017/0127039 A1
(43) Pub. Date: May 4, 2017

(54) ULTRASONIC PROXIMITY DETECTION SYSTEM

(71) Applicant: MEDIATEK INC., Hsin-Chu (TW)

(72) Inventors: Hsuan-Ming LIU, Hsinchu City (TW); Cheng-Che CHAN, Zhubei City (TW); Po-Hsun LIN, Taipei City (TW); Cheng-Che CHEN, New Taipei City (TW)

(21) Appl. No.: 15/334,255

(22) Filed: Oct. 25, 2016

Related U.S. Application Data
(60) Provisional application No. 62/249,654, filed on Nov. 2, 2015.

(51) Int. Cl. H04N 13/00; H04N 5/265; H04N 5/232; H04N 13/02; H04N 13/04

(52) U.S. Cl. CPC H04N 13/0022; H04N 13/0239; H04N 13/04; H04N 5/23293; H04N 5/265

(57) ABSTRACT

A portable device and a method for display delay enhancement in a depth application running on the portable device are provided. The portable device includes: a dual camera device, continuously capturing a sequence of frame pairs; a video encoder; a display; a processor, configured to obtain a first depth map associated with one or more previous frame pairs of the frame pairs, and generate a first output image based on a current frame pair of the frame pairs and the first depth map associated with the one or more previous frame pairs, and sends the first output image to the display. The processor obtains a second depth map associated with the current frame pair, and generates a second output image based on the current frame pair and the second depth map associated with the previous frame pair, and sends the second output image to the video encoder.

### CROSS REFERENCE TO RELATED APPLICATIONS

This application claims the benefit of U.S. Provisional Application No. 62/249,654, filed on Nov. 2, 2015, the entirety of which is incorporated by reference herein.

### BACKGROUND OF THE INVENTION

Field of the Invention

The invention relates to image processing, and, in particular, to a portable device and an associated method for display delay enhancement in a depth application.

Description of the Related Art

Advances in technology have resulted in smaller and more powerful portable devices. It is common for a user to use a portable device to capture images or record videos. However, the system resources in a portable device are very limited. It is time-consuming to build preview images or video images having depth information due to the high complexity of calculation of depth information. There may be a significant delay between the start of the image-capturing and the displaying of the first preview image in a conventional portable device, even if the calculation has been distributed into image-processing pipelines. As a result, there is demand for a portable device and an associated method to reduce the display delay seen in conventional portable devices.

### BRIEF SUMMARY OF THE INVENTION

A detailed description is given in the following embodiments with reference to the accompanying drawings.

In an exemplary embodiment, a portable device is provided. The portable device includes: a dual camera device, continuously capturing a sequence of frame pairs; a video encoder; a display; a processor, configured to obtain a first depth map associated with one or more previous frame pairs of the frame pairs, and generate a first output image based on a current frame pair of the frame pairs and the first depth map associated with the one or more previous frame pairs, and sends the first output image to the display. The processor obtains a second depth map associated with the current frame pair, and generates a second output image based on the current frame pair and the second depth map associated with the previous frame pair, and sends the second output image to the video encoder.

In another exemplary embodiment, a portable device is provided. The portable device includes: a dual camera device, configured to continuously capture a sequence of frame pairs; a video encoder; a display; and a processor, configured to obtain a depth map associated with a previous frame pair of the frame pairs, generate a first output image based on a current frame pair of the frame pairs and the depth map associated with the previous frame pair, and generate a second output image based on the previous frame pair and the depth map associated and the previous frame pair, wherein the processor sends the first output image and the second output image to the display and the video encoder, respectively.

In another exemplary embodiment, a method for display delay enhancement in a depth application running on a portable device is provided. The portable device includes a dual camera device, a video encoder, and a display, the method comprising: continuously utilizing the dual camera device to capture a sequence of frame pairs; obtain a first depth map associated with one or more previous frame pairs of the frame pairs; generating a first output image based on a current frame pair of the frame pairs and the first depth map associated with the one or more previous frame pairs; sending the first output image to the display; obtaining a second depth map associated with the current frame pair of the frame pairs, and generates a second output image based on the current frame pair of the frame pairs and the second depth map associated with the previous frame pair; and sending the second output image to the video encoder.

In yet another exemplary embodiment, a method for display delay enhancement in a depth application running on a portable device is provided. The portable device includes a dual camera device, a video encoder, and a display, the method comprising: utilizing the dual camera device to continuously capture a sequence of frame pairs; obtaining a depth map associated with a previous frame pair of the frame pairs; generating a first output image based on a current frame pair of the frame pairs and the depth map associated with the previous frame pair; generating a second output image based on the previous frame pair and the depth map associated and the previous frame pair; and sending the first output image and the second output image to the display and the video encoder, respectively.

### BRIEF DESCRIPTION OF THE DRAWINGS

The invention can be more fully understood by reading the subsequent detailed description and examples with references made to the accompanying drawings, wherein:

FIG. 1 is a diagram of a portable device in accordance with an embodiment of the invention;

FIG. 2 is a diagram illustrating frame delay for two output paths in a conventional portable device;

FIG. 3 is a diagram illustrating frame delay for two output paths in the portable device in accordance with a first embodiment of the invention;

FIG. 4 is a diagram illustrating frame delays for two output paths in the portable device in accordance with a second embodiment of the invention;

FIG. 5A is a flow chart of a method for display delay enhancement in a depth application running on a portable device in accordance with an embodiment of the invention;

FIG. 5B is a flow chart of a method for display delay enhancement in a depth application running on the portable device in accordance with another embodiment of the invention; and

FIGS. 6A˜6I are diagrams illustrating the flow of depth map fusion process in accordance with an embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

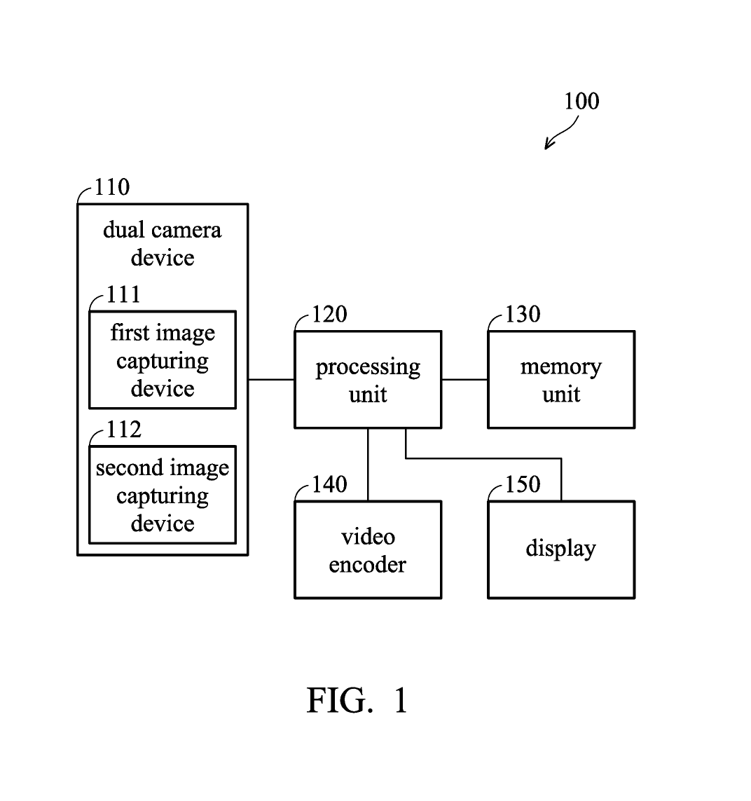

FIG. 1 is a diagram of a portable device in accordance with an embodiment of the invention. In an embodiment, the portable device 100 includes a dual camera device 110, a processing unit 120, a memory unit 130, a video encoder 140, and a display 150. For example, the portable device 100 may be a smartphone, a tablet PC, or any other electronic device with related functions. The dual camera device 110 includes a first image capturing device 111 and a second image capturing device 112, which may be a left-eye camera and a right-eye camera to capture a left-eye image and a right-eye image (i.e. an frame pair), respectively. The processing unit 120 may include one or more processors, digital signal processors (DSPs), or image signal processors (ISPs), and the processing unit 120 is configured to calculate a first depth map associated with one or more previous frame pairs of a sequence of frame pairs that is continuously captured by the dual camera device 110. The continuous capturing of the sequence of frame pairs by the dual camera device 110 can be regarded as periodically and repeatedly capturing frames of a scene by the dual camera device 110. The processing unit 120 further generates a first output image based on a current frame pair of the frame pairs and the first depth map, and sends the first output image to the display 150 for image previewing. frame pair. In an embodiment, the processing unit 120 further obtains a second depth map associated with the current frame pair of the frame pairs, generates a second output image based on the current frame pair and the second depth map, and sends the second output image to the video encoder 140 for subsequent video encoding processes. The memory unit 130 may be a volatile memory such as a dynamic random access memory (DRAM), and is configured to store the frame pairs captured by the dual camera device 110. The depth images associated with the captured frame pairs and the first and second output images are also stored in the memory unit 130. More specifically, while generating the first output image, the processing unit 120 applies an algorithm for image processing to the current frame pair with reference to the first depth map associated with the previous frame pair. In addition, while generating the second output image, the processing unit 120 applies the algorithm for image processing to the current frame pair with reference to the second depth map associated with the current frame pair. The algorithm for image processing mentioned above could be Bokeh effect algorithm (e.g. emphasizing the depth information in a two-dimensional image) for example. The Bokeh effect algorithm for image processing is well known for people of ordinary skill in the art thus is not described here for brevity.

There are two output paths for the output images stored in the memory unit 130. The first output path is an image previewing path, and the second output path is a video recording path. In the first output path, the first output image is directly sent to the display 150 for image previewing. In the second output path, the second output image is sent to the video encoder 140, and the video encoder 140 performs video encoding on the second output image. In order to reduce the delay when displaying preview image, the first depth map associated with the previous frame pairs is referenced for the first output image. On the other hand, to enhance image processing effect and quality in recorded image data, the second depth map associated with the current frame pairs is referenced for the second output image. The video encoder 140 may be an integrated circuit (IC) or a system-on-chip (SoC) to perform real-time video compression.

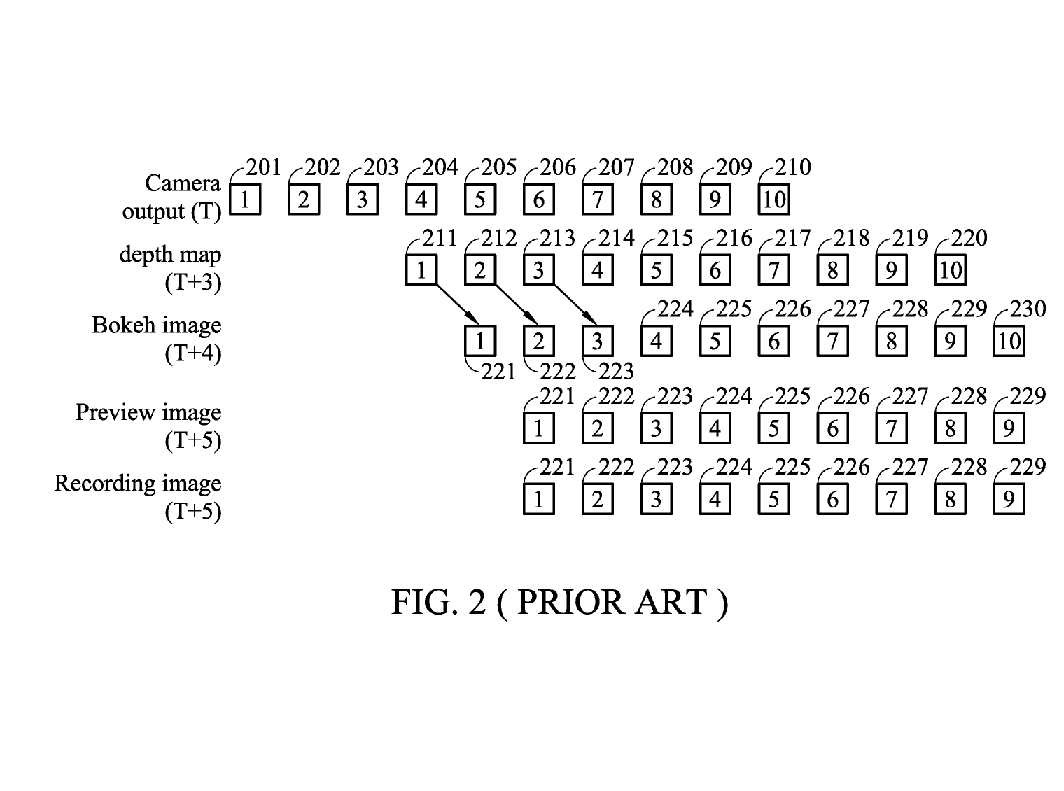

FIG. 2 is a diagram illustrating frame delay for two output paths in a conventional portable device. As shown in FIG. 2, the number shown in each block represents the order or the sequence of the images. Blocks with the same number in different stages, such as camera output, depth maps, Bokeh images, preview images, recording images, indicate the same images shift along with time during each stage. In the conventional portable device, it takes a 3-frame-delay to compute the depth map for a frame pair. For example, the depth map 211 associated the image 201 is generated when the image 204 is captured. When applying the Bokeh effect algorithm to the image 201, the image 201 and the associated depth map 211 are used, and it takes a one-frame-delay for applying the Bokeh effect algorithm to the image 201. Accordingly, the output image 221 applied with the Bokeh effect is generated when the image 205 is captured, and thus the output image 221 can be output to the image previewing path and the video recording path when image 206 is captures.

One having ordinary skill in the art will appreciate that there is a five-frame-delay between the first captured image 201 and the output image for both preview and recording. It should be noted that the two output paths in the conventional portable device share the same output image. For example, the output image 221 applied with the Bokeh effect algorithm is generated at time T+4, and the output image 221 is sent to both the image previewing path and the video recording path.

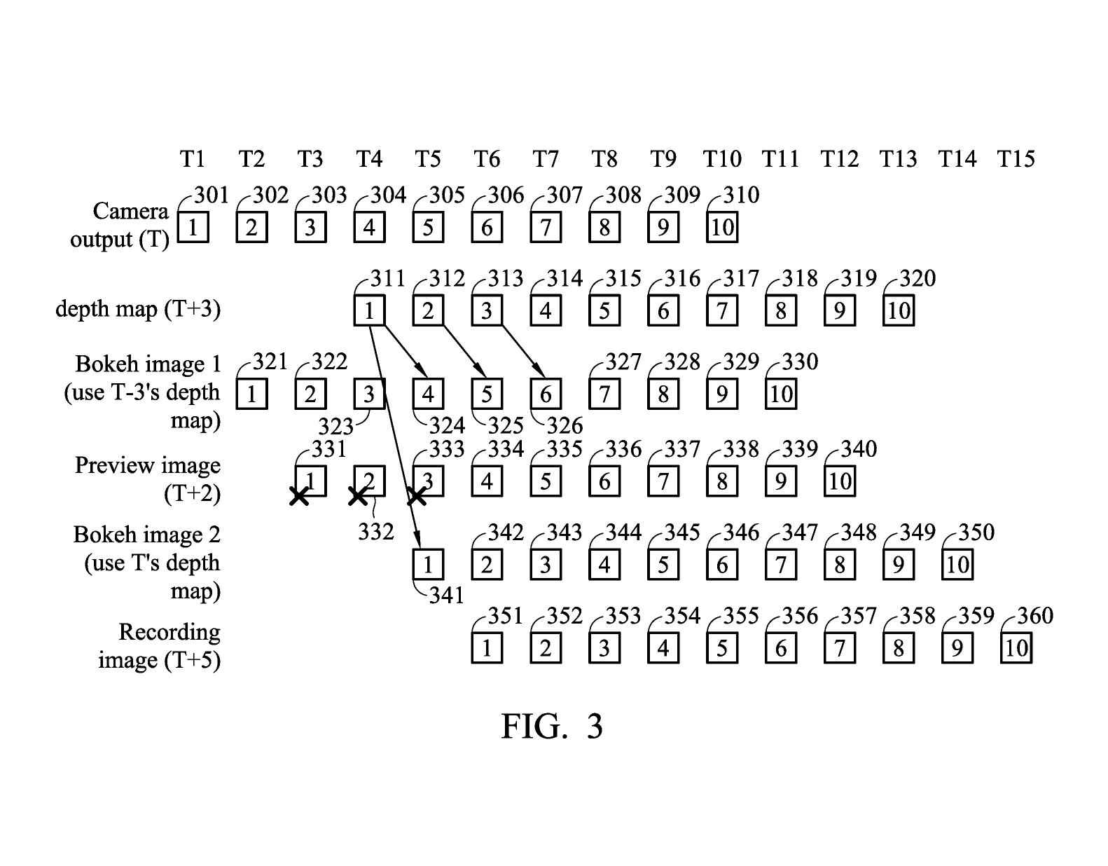

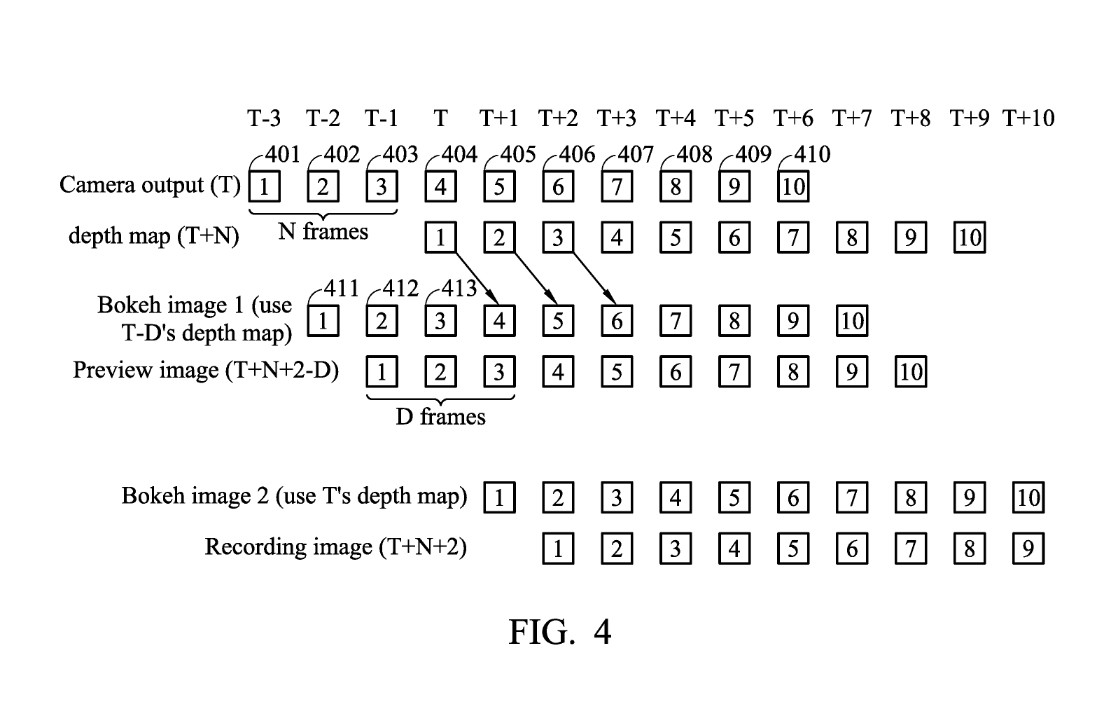

FIG. 3 is a diagram illustrating frame delay for two output paths in the portable device in accordance with a first embodiment of the invention. As shown in FIG. 3, the number shown in each block represents the order or the sequence of the images. Blocks with the same number in different stages, such as camera output, depth maps, Bokeh images, preview images, recording images, indicate the same images shift along with time during each stage. Similar to FIG. 2, it also takes a 3-frame-delay to compute the depth map for a frame pair, and it also takes a one-frame-delay to compute the Bokeh image for the frame pair. In this embodiment, the Bokeh image at time T uses the depth map at time T−3. For example, the depth image 311 from the frame pair 301 (at time T1) is available at time T4, and the Bokeh image 324 from the frame pair 304 is obtained at time T5.

However, the depth maps from the first three frame pairs 301, 302, 303 are not available until time T4, T5, and T6, respectively. Instead, an empty depth map is used to represent the absent depth map of the first three frame pairs 301, 302, and 303 in the boundary cases, and thus the Bokeh images 321, 322, and 323 can be obtained at time T2, T3, and T4, respectively. Accordingly, the first preview image 331 can be output to the display 150 at time T3. Similarly, the preview images 332 and 333 can be output to the display 150 at time T4 and T5, respectively. It should be noted that the first three preview images 331, 332, and 333 do not have depth information and the Bokeh effect due to the absence of depth maps. However, the first preview image 331 can be obtained three frames earlier than the conventional techniques shown in FIG. 2. Assuming that the dual camera device 110 captures images at a frame rate of 30 images/second, it only takes 0.1 sec to display first three preview images.

In the embodiment, the depth map 311 from the first frame pair 301 is obtained at time T4. However, the Bokeh image 324 is computed using the depth map 311 and the frame pair 304 at time T5. Similarly, the Bokeh image 325 is computed using the depth map 312 and the frame pair 305. Specifically, the Bokeh image to be rendered on the display 150 in the image previewing path is computed using the current frame and the depth map of the latest frame pair. In some embodiments, the Bokeh image to be rendered on the display 150 in the image previewing path is computed using the current frame and the depth map of the selected previous frame pair.

It should be noted that video quality is crucial in the video recording path, and thus the output Bokeh image for the video recording path always use the frame pair with the depth map of the same time point. Accordingly, the first output Bokeh image 341 to the video recording path is computed using the first frame pair 301 and the depth map 311 thereof at time T5 to ensure the video quality, and the Bokeh image 341 is sent to the video encoder 140 at time T6 for subsequent video encoding processes. One having ordinary skill in the art will appreciate that there is a five-frame-delay between the first output Bokeh image 351 and the first frame pair 301.

FIG. 4 is a diagram illustrating frame delays for two output paths in the portable device in accordance with another embodiment of the invention. FIG. 4 illustrates a general case of the frame delays for two output paths, and the delays can be represented by a specific parameter. For example, given that the frame pair is received at time T, the depth image from the same frame pair is obtained at T+N, where N denotes the frame delay to obtain the depth map. The Bokeh images 1 for the frame pair at time T is computed using the frame pair at time T and the depth image at time T−D, where D denotes the frame delay between the current frame and the depth map to be used, and D is smaller than or equal to N. It should be noted that the Bokeh images 1 can still be computed even if the depth map for the frame pair is unavailable. As described in the embodiment of FIG. 3, an empty depth map is used for the Bokeh images 411, 412, and 413 in the boundary cases. It requires a one-frame-delay at minimum to generate the Bokeh image for the frame pair, and it also requires another one-frame-delay to send the generated Bokeh image to the image previewing path. Accordingly, the frame delay between the frame pair and the associated preview image is N+2−D. For illustrative purposes, N and D are set to 3 in this embodiment.

Regarding the video recording path, similar to the embodiment in FIG. 3, the computation of the output Bokeh image for the video recording path always uses the frame pair and the depth map from the same time point (i.e., using the previous frame pair and the depth map associated with the previous frame pair because the depth map associated with the current frame pair has not been generated yet), and thus the details will be omitted here.

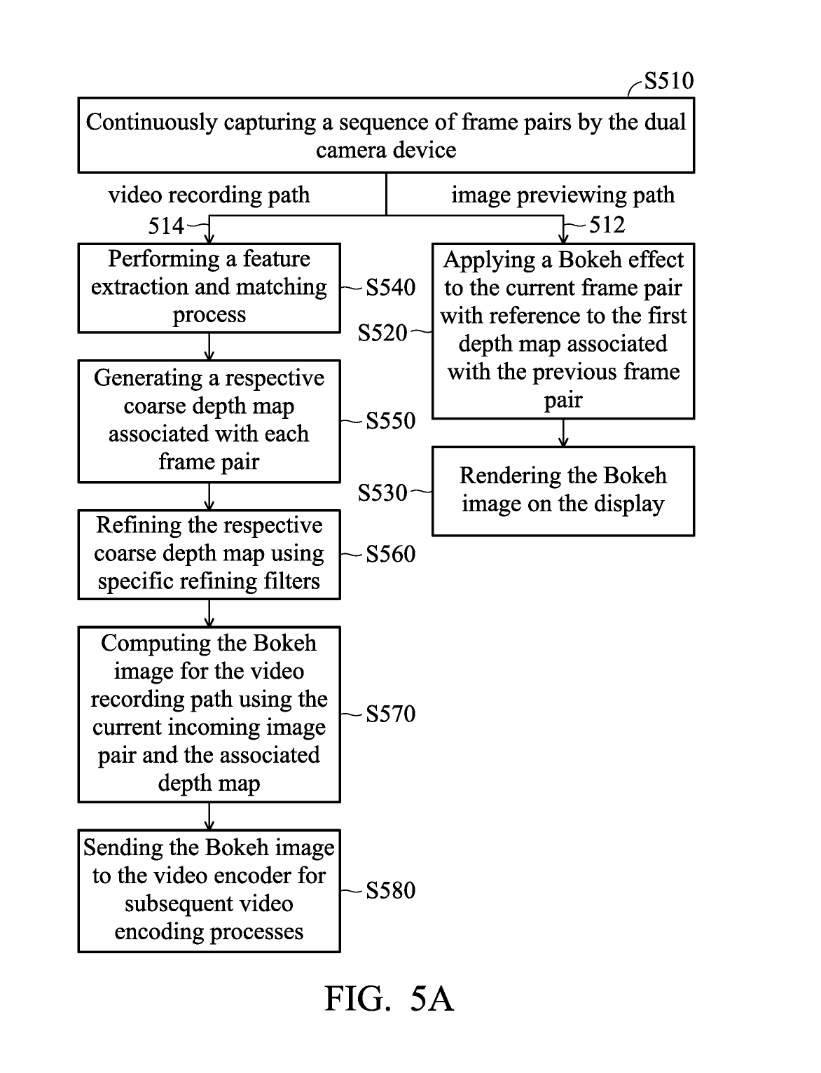

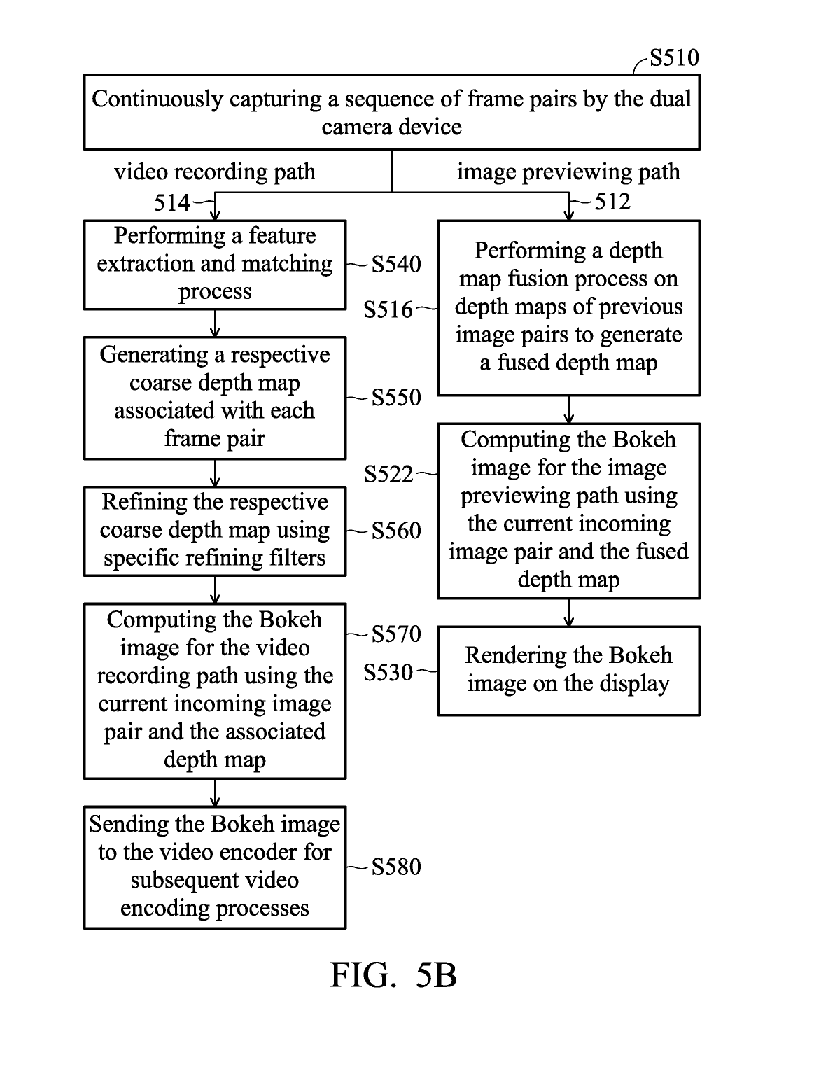

FIG. 5A is a flow chart of a method for display delay enhancement in a depth application running on a portable device in accordance with an embodiment of the invention. In step S510, a sequence of frame pairs is continuously captured by the dual camera device 110. The current frame pair is sent to two different paths such as the image previewing path and video recording path for subsequent processing. When entering the image previewing path (arrow 512), by applying a Bokeh effect algorithm to the current frame pair with reference to the first depth map associated with the previous frame pair (step S520). For example, the previous frame is captured D frames earlier than the current frame pair, where D is a positive integer. It should be noted that the aforementioned first depth map is a refined depth map as described in step S560. In step S530, the Bokeh image (i.e. a first output image) for the image previewing path is rendered on the display 150.

When entering the video recording path (arrow 514), a feature extraction and matching process is performed on each frame pair (step S540). For example, the image features, such as edges, corners, interest points, regions of interests, ridges, etc., are extracted from each frame pair, and feature matching is performed to compare the corresponding parts in each frame pair. In step S550, a respective coarse depth map associated with each frame pair is generated. For example, when the corresponding points between the frame pair are found, the depth information of the frame pair can be recovered from their disparity. In step S560, the respective coarse depth map of each frame pair is further refined using specific refining filters to obtain the respective depth map associated with each frame pair. One having ordinary skill in the art will appreciate that various techniques can be used to refine the depth map, and the details will be omitted here. In step S570, the Bokeh image is computed by applying a Bokeh effect algorithm to the current frame pair with reference to the depth map associated with the current frame pair after the depth map associated with the current frame pair is available. In step S580, the Bokeh image (i.e. a second output image) for the video recording path is sent to the video encoder 140 for subsequent video encoding processes.

For implementation, the frame pairs and their depth maps are stored and queued in the memory unit 130, and the number of stored frame pairs and depth maps depends on the value of D and N as described in FIG. 4. When the output Bokeh image associated with a specific frame pair at time T for the video recording path has been sent to the video encoder 140, the specific image can be discarded from the memory unit 130 since computation of the Bokeh image for the video recording path is always later than that for the image previewing path. In addition, when the output Bokeh image associated with the specific image at time T for the image previewing path has been sent to the display 150, the depth map associated with the frame pair at time T−D can be discarded from the memory unit 130.

FIG. 5B is a flow chart of a method for display delay enhancement in a depth application running on the portable device in accordance with another embodiment of the invention. In the embodiment of FIG. 5B, a technique of depth map fusion is utilized in the method. The steps for the video recording path in FIG. 5B is similar to those in FIG. 5A, and the details will be omitted here. Regarding the image previewing path in FIG. 5B, in step S516, a depth map fusion process is performed on depth maps of previous frame pairs to obtain a fused depth map. For example, the depth map fusion process is to eliminate artifacts produced by reciprocating motion in the frames. The reciprocating motion is a repetitive up-and-down or back-and-forth linear motion, and the details for the depth map fusion process will be described later. In step S522, the Bokeh image for the image previewing path is computed using the current frame pair (e.g at time T) and the fused depth map. In step S530, the Bokeh image for the image previewing path is rendered on the display 150.

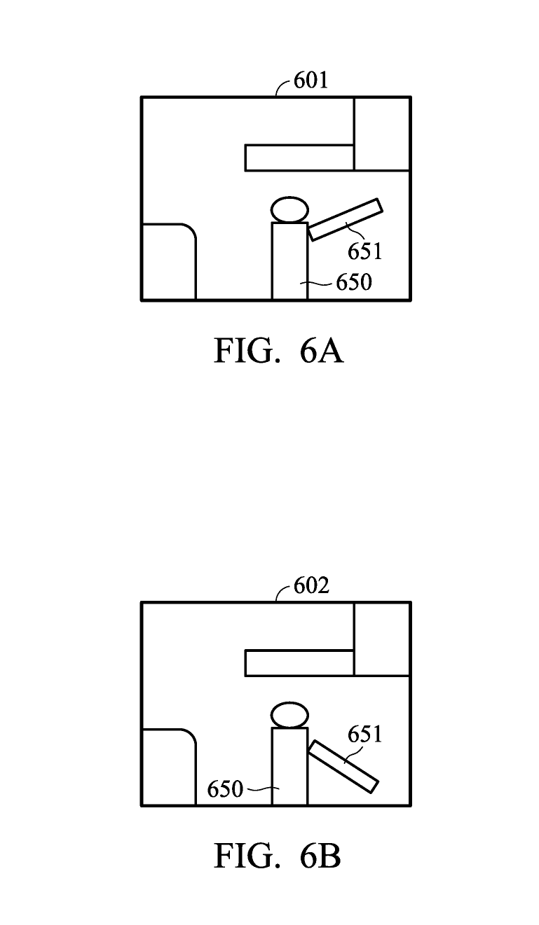

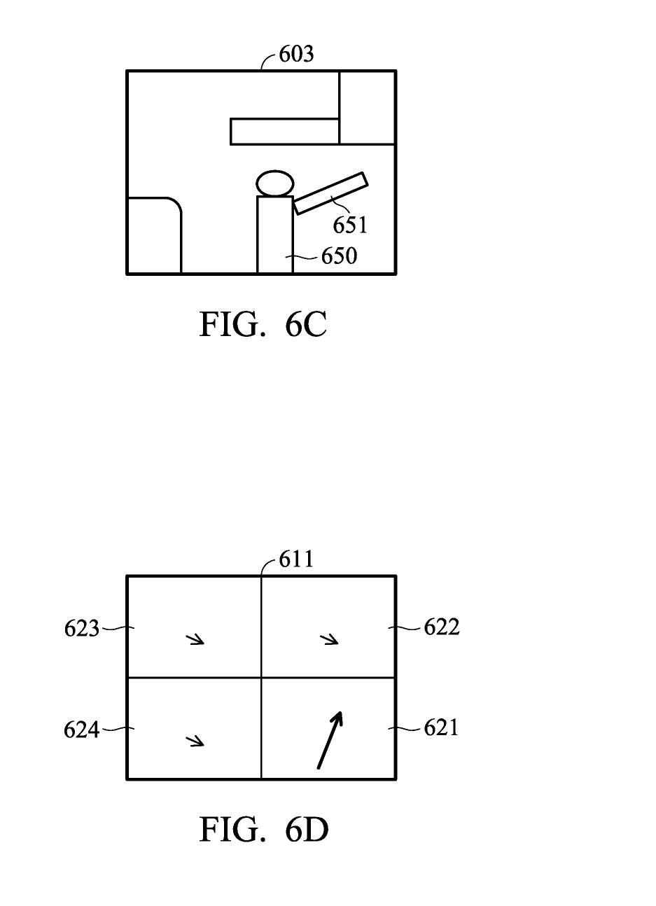

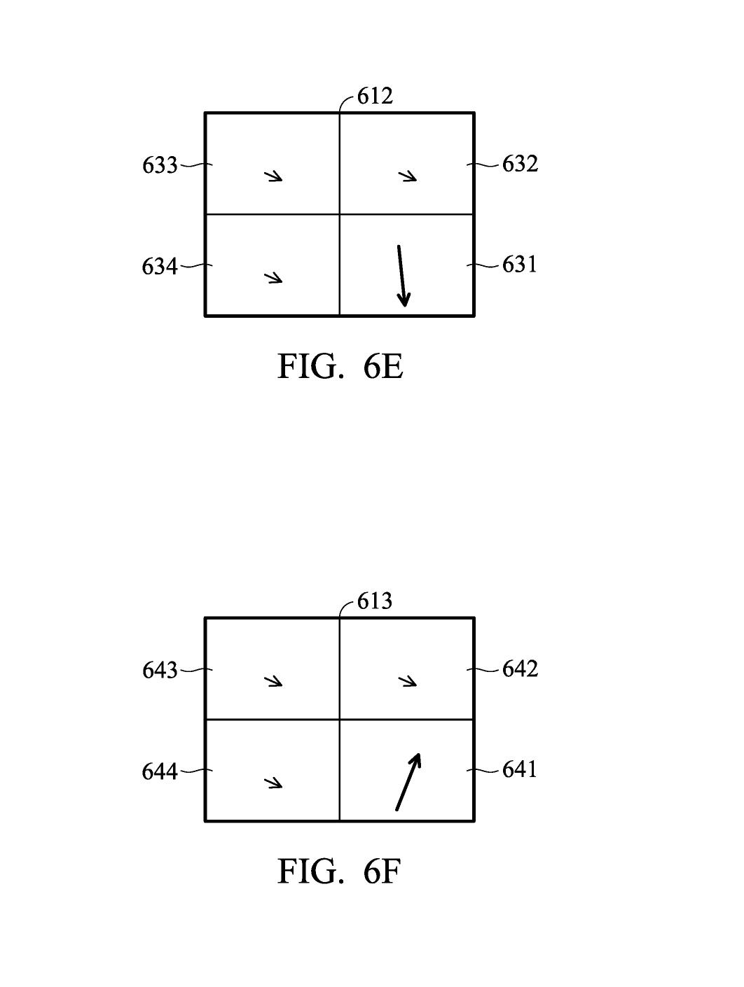

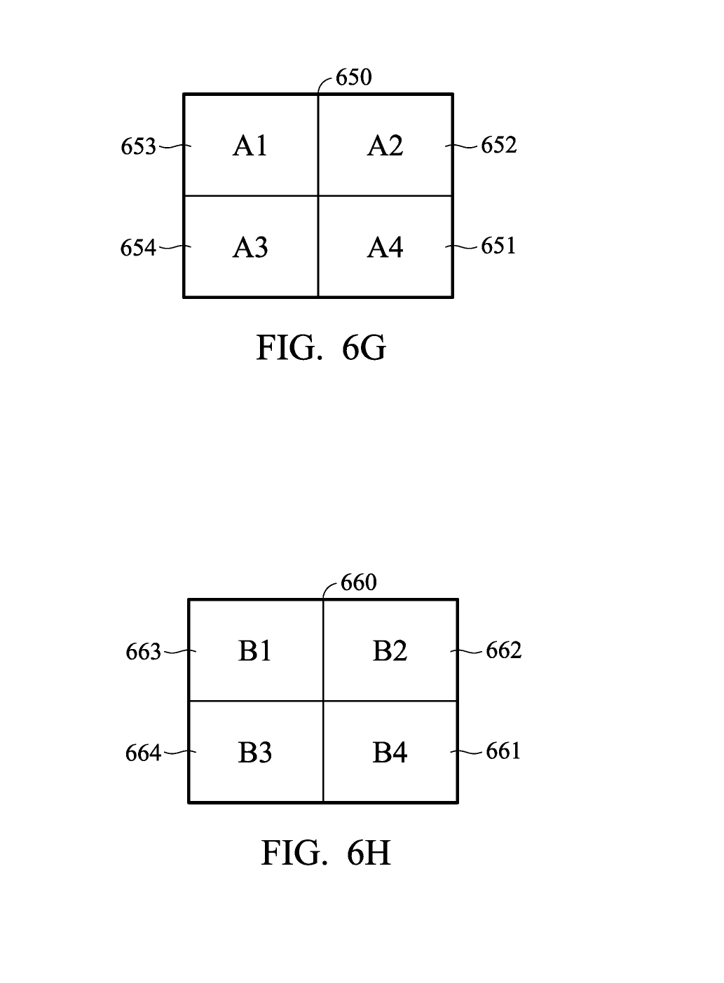

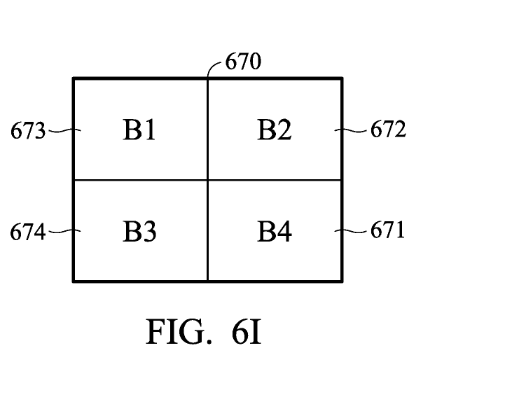

FIGS. 6A˜6I are diagrams illustrating the flow of the depth map fusion process in accordance with an embodiment of the invention. FIGS. 6A˜6C show frame 601, frame 602, and frame 603, respectively. FIGS. 6D˜6F shows the motion vector map of each block in frames 601, 602, and 603, respectively. FIGS. 6G˜6I shows the depth map of each block in frames 601, 602, and 603, respectively. For illustrative purposes, each frame shown in FIGS. 6A-6C represents an frame pair. For example, the arm 651 of the user 650 has a reciprocating motion in frames 601, 602, and 603. The motion vectors in the right-bottom blocks 621, 631, and 641 associated with the frames 601, 602 and 603 are toward right-upper, right-bottom, and right-upper, as shown in FIGS. 6D˜6F. In addition, other blocks in the frames 601, 602 and 603 are almost stationary. Assuming that the frame 603 is the current frame to be rendered for image previewing, the processing unit 120 may calculate the motion difference of each block in the current frame (i.e. frame 603) and associated co-located block in the previous frames (i.e. frames 601 and 602). For example, the motion vector shown in FIGS. 6D˜6F can be used to calculate the motion difference. It should be noted that the depth maps of the frames 601 and 602 are available when the current frame pair is the frame 603. Specifically, there are four blocks 651˜654 in the depth map 650 associated with the frame 601, and there are also four blocks 661˜664 in the depth map 660 associated with the frame 602, and there are also four blocks 671˜674 in the depth map 670 associated with the frame 603. For example, the blocks 651 and 661 are co-located blocks of the block 671. One having ordinary skill in the art will appreciate the co-located blocks of other blocks 672, 673, and 674, and the details will be omitted here.

In an embodiment, the processor 120 may calculate the motion difference between the motion vector 641 and each of the motion vectors in the motion vector block of previous frames. For example, the motion difference between the motion vectors 641 and 631 is calculated, and the motion difference between the motion vectors 641 and 621 is also calculated. It should be noted that there may be a plurality of frames between the frames 602 and 603. The processor 120 may calculate the motion difference between each motion vector block in the current frame and associated co-located motion vector blocks in previous frames, and determine the motion vector block having the minimum motion difference. If more than one motion vector block have the minimum motion difference, the motion vector block closet to the current frame is selected.

For example, the motion vectors in motion vector blocks 641 and 621 may have the minimum motion difference, and thus the block 671 in the depth map 670 will be filled with the content of the block 651. In addition, the motion differences between the motion vector blocks 642 and 632, and between the motion vector blocks 642 and 622 may be very small. In other words, there are more than one motion vector block that have the minimum motion difference. Then, the processing unit 120 may select the block 662 in the depth map 660 as the block to be filled into the block 672 in the depth map 670. Similarly, the blocks 663 and 664 are selected as the blocks to be filled into the blocks 673 and 674 in the depth map 670, respectively. Accordingly, the depth map fusion process is performed, and a “fused” depth map 670 is generated.

In view of the above, a portable device and a method for display delay enhancement in a depth application running on the portable device are provided. The portable device may generate a first output image and a second output image to the display for image previewing and the video encoder for encoding, and the display of the first output image on the display is earlier than encoding the second output image by the video encoder. Since the user is less sensitive to the preview images, the portable device is capable of generating several first output images without using depth information when image previewing starts. Meanwhile, the video encoder always uses the current frame and the associated depth map for video encoding, thereby ensuring the quality of the video of the encoded video file. Specifically, the portable device and the method are capable of reducing the display delay in the image previewing path without sacrificing too much image quality. Meanwhile, the image quality of the video recording path can be maintained at a high quality.

While the invention has been described by way of example and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A portable device, comprising:
a dual camera device, configured to continuously capture a sequence of frame pairs;
a video encoder;
a display; and
a processor, configured to obtain a first depth map associated with one or more previous frame pairs of the frame pairs, and generate a first output image based on a current frame pair of the frame pairs and the first depth map associated with the one or more previous frame pairs, and sends the first output image to the display,
wherein the processor further obtains a second depth map associated with the current frame pair of the frame pairs, and generates a second output image based on the current frame pair of the frame pairs and the second depth map associated with the current frame pair, and sends the second output image to the video encoder.

2. The portable device as claimed in claim 1, wherein the processor sends the first output image to the display before it sends the second output image to the encoder.

3. The portable device as claimed in claim 1, wherein in generating the first output image, the processor applies an image processing to the current frame pair with reference to the first depth map associated with the previous frame pair.

4. The portable device as claimed in claim 3, wherein the image processing is Bokeh effect algorithm.

5. The portable device as claimed in claim 1, wherein in generating the second output image, the processor applies a Bokeh effect algorithm to the current frame pair with reference to the depth map associated with the current frame pair after the depth map associated with the current frame pair is available.

6. The portable device as claimed in claim 1, wherein in generating a respective depth map for each of the frame pairs, the processor performs a feature extraction and matching process on the each frame pair to generate a respective coarse depth map, and applies a refining filter to the respective coarse depth map to obtain the respective depth map associated with the each frame pair.

7. The portable device as claimed in claim 1, wherein the processor further performs a depth map fusion process on the depth maps of the previous frame pairs to obtain a fused depth map, and applies a Bokeh effect algorithm to the current frame pair with reference to the fused depth map to generate the first output image.

8. The portable device as claimed in claim 7, wherein in the depth map fusion process, each of the previous frame pairs is divided into a plurality of blocks, wherein the processor further calculates motion difference between each block of the current frame pair and an associated co-located block in each of the previous frame pairs, and selects the co-located block having the minimum motion difference from the depth maps of the previous frame pairs to generate the fused depth map.

9. A portable device, comprising:
a dual camera device, configured to continuously capture a sequence of frame pairs;
a video encoder;
a display; and
a processor, configured to obtain a depth map associated with a previous frame pair of the frame pairs, generate a first output image based on a current frame pair of the frame pairs and the depth map associated with the previous frame pair, and generate a second output image based on the previous frame pair and the depth map associated and the previous frame pair,
wherein the processor sends the first output image and the second output image to the display and the video encoder, respectively.

10. The portable device as claimed in claim 9, wherein the processor sends the first output image to the display and sends the second output image to the video encoder simultaneously.

11. A method for display delay enhancement in a depth application running on a portable device, wherein the portable device includes a dual camera device, a video encoder, and a display, the method comprising:
continuously utilizing the dual camera device to capture a sequence of frame pairs;
obtain a first depth map associated with one or more previous frame pairs of the frame pairs;
generating a first output image based on a current frame pair of the frame pairs and the first depth map associated with the one or more previous frame pairs;
sending the first output image to the display;
obtaining a second depth map associated with the current frame pair of the frame pairs, and generates a second output image based on the current frame pair of the frame pairs and the second depth map associated with the current frame pair; and
sending the second output image to the video encoder.

12. The method as claimed in claim 11, further comprising:
sending the first output image to the display before sending the second output image to the encoder.

13. The method as claimed in claim 11, further comprising:
applying an image processing to the current frame pair with reference to the first depth map associated with the previous frame pair when generating the first output image.

14. The method as claimed in claim 13, wherein the image processing is Bokeh effect algorithm.

15. The method as claimed in claim 11, further comprising:
applying a Bokeh effect algorithm to the current frame pair with reference to the depth map associated with the current frame pair after the depth map associated with the current frame pair is available when generating the second output image.

16. The method as claimed in claim 11, wherein when generating a respective depth map for each frame pair, the method further comprises:
performing a feature extraction and matching process on the each frame pair to generate a respective coarse depth map; and
applying a refining filter to the respective coarse depth map to obtain the respective depth map associated with each frame pair.

17. The method as claimed in claim 11, further comprising:
performing a depth map fusion process on the depth maps of the previous frame pairs to obtain a fused depth map; and
applying a Bokeh effect to the current frame pair with reference to the fused depth map to generate the first output image.

18. The method as claimed in claim 15, wherein in the depth map fusion process, each of the previous frame pairs is divided into a plurality of blocks, and the method further comprises:
calculating motion difference between each block of the current frame pair and an associated co-located block in each of the previous frame pairs; and
selecting the co-located block having the minimum motion difference from the depth maps of the previous frame pairs to generate the fused depth map.

19. A method for display delay enhancement in a depth application running on a portable device, wherein the portable device includes a dual camera device, a video encoder, and a display, the method comprising:
utilizing the dual camera device to continuously capture a sequence of frame pairs;
obtaining a depth map associated with a previous frame pair of the frame pairs;
generating a first output image based on a current frame pair of the frame pairs and the depth map associated with the previous frame pair;
generating a second output image based on the previous frame pair and the depth map associated and the previous frame pair; and
sending the first output image and the second output image to the display and the video encoder, respectively.

20. The method as claimed in claim 19, further comprising:
sending the first output image to the display and sends the second output image to the video encoder simultaneously.
